(19) United States
(12) Patent Application Publication
(10) Pub. No.: US 2020/0166424 A1
(43) Pub. Date: May 28, 2020

(54) Capacitive Pressure Sensor

(71) Applicant: Guanghua Wu, McKinney, TX (US)

(72) Inventor: Guanghua Wu, McKinney, TX (US)

(21) Appl. No.: 16/501,462

(22) Filed: Oct. 5, 2018

(51) Int. Cl. G01L 9/00; G01L 13/02; G01L 27/00; G01L 9/12

(52) U.S. Cl. CPC G01L 9/0072; G01L 9/125; G01L 27/005; G01L 13/025

(57) ABSTRACT

A variable capacitance type pressure sensor is constructed by only using semi-conductor industry accepted metals and materials in the wetted surface. PCTFE or PTFE by injection molding or compression molding is used to join components together and provide sealing and electrical isolation. No oil filling is needed. The sensor can measure both differential pressure and line pressure. Implanted temperature sensor is used to do thermal calibration and temperature compensation.

### BACKGROUND OF THE INVENTION

In food, medicine and especially semiconductor industries, there is a very strict requirement for the materials used in components which have contact with process fluid. Semi-conductor industry has the strictest request for the materials which have contact with process fluid, as specified in SEMI F1107. The strict material requirement in semiconductor industry posts a serious challenge for the manufacturing of pressure sensors intended to use in semiconductor industry. Diaphragm is often used to isolate medium and sensing element. To transfer pressure, silicone oil is often used to fill the cavity between diaphragm and sensing element. The disadvantage of using oil-filling are: oil gravity will shift sensor's zero output reading, oil's expansions under temperature change will produce a false pressure reading, oil leak due to overpressure of manufacturing defect will contaminate the system, costing millions of dollars, especially in semiconductor industry, and the manufacture cost is high.

### SUMMARY OF THE INVENTION

One object of this invention is to construct a pressure sensor by only using SEMI accepted metals and PCTFE or PTFE.

Another object of this invention is to avoid using oil filling.

Another object of this invention is to use the same sensor measuring both differential pressure and line pressure. In the application of pressure-based mass flow controller, differential pressure sensor is used to measure the pressure difference across a laminar flow element as an indication of flow rate. The flow rate is related to pressure drop across the laminar flow element and line pressure. One differential pressure sensor and one absolute pressure sensor can be used together. But if one pressure sensor can measure both differential pressure and line pressure, it will save the cost and the space.

Another object is to make the pressure sensor as small as possible. Most of the pressure sensors on market are not small enough to fit in a Mass Flow Controller, which is typically 1.125″ (28.6 mm) wide. To fit in a Mass Flow Controller, the diameter of the final product should be around 25 mm or less.

Another object of this invention is to make the cost of the pressure sensor as low as possible.

In one aspect, a pressure sensor is constructed by using only the materials accepted by semi-conductor industry in its fluid path. Polychlorotrifluoroethylene (PCTFE) or Polytetrafluoroethylene (PTFE) or other polymer is used to join the parts together, by injection molding or compression molding to form variable capacitors. At the same time, the PCTFE or PTFE seam(s) also plays a sealing role between fluid and environment and an electrical isolation role between stainless steel parts. No oil filling is needed. The pressure sensor can measure both differential pressure and line pressure. One variable capacitor can be used to compensate the deformation caused by internal medium pressure and at the same time measure the line pressure. A temperature sensor is used to calibrate the influence of temperature and the results are saved in circuit's memory. In operation, the data saved is used to compensate the temperature's influence.

### BRIEF DESCRIPTION OF THE DRAWINGS

FIG. 1 is a section view of one embodiment of the invention.

FIGS. 2A and 2B are section view and detail view of the upstream disk 34 of one embodiment of the invention.

FIG. 3 is a section view of an example of PCTFE or PTFE seam.

FIG. 4 is a sketch showing part of PCTFE injection molding process.

FIG. 5 is an isometric view of upstream outside welding ring 14.

FIG. 6 is a sketch showing PTFE power pressing fixture and pressing process.

FIG. 7 shows a typical PTFE sintering temperature profile.

FIG. 8 is an isometric view of printed circuit board 30.

FIGS. 9A and 9B show the covers assembling procedures of the invention.

FIG. 10 is a drawing for FEM (finite element method) thermal analysis.

FIG. 11 shows the relationship obtained by FEM between the change of gaps d1, d2 and room temperature change.

FIG. 12 is a drawing for internal pressure FEM analysis.

FIG. 13 shows the relationship between the increase of gap d1 and internal pressure.

FIG. 14 shows the relationship between the maximum shear stress of PCTFE or PTFE seam and internal pressure.

### DETAILED DESCRIPTION OF THE INVENTION

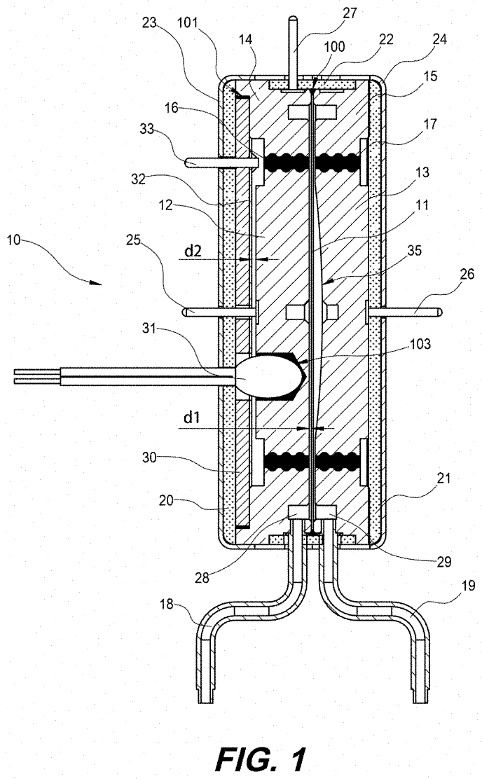

One aspect of the invention is shown in FIG. 1. The pressure sensor 10 is consist of a diaphragm 11, upstream electrode 12, downstream electrode 13, upstream outside welding ring 14 and downstream outside welding ring 15, PCTFE or PTFE seams 16, 17, upstream tube 18, downstream tube 19, side isolations 20, 21, ring isolation 22, covers 23, 24, leads 25, 26, 27, printed circuit board 30 and temperature sensor 31.

Diaphragm 11 is preferred to be made of 316L, 316 VIM/VAR, or Inconel. Its thickness is between 0.0005″ to 0.005″ (0.013 to 0.13 mm), depending the pressure range to measure. It is welded by TIG or laser welding (100) to outside welding rings 14 and 15, which are also preferred to be made of 316L, 316L VIM/VAR, or Inconel. After welding, there is a gap d1 formed between diaphragm 11 and upstream electrode 12. Diaphragm 11 and upstream electrode 12 will form an upstream variable capacitor. Lead 27, outside welding ring 14 and diaphragm 11 form one pole, lead 25 and electrode 12 form another pole. Diaphragm 11 and downstream electrode 13 will also form a downstream variable capacitor. Lead 27, outside welding ring 15 and diaphragm 11 form one pole, lead 26 and electrode 13 form another pole.

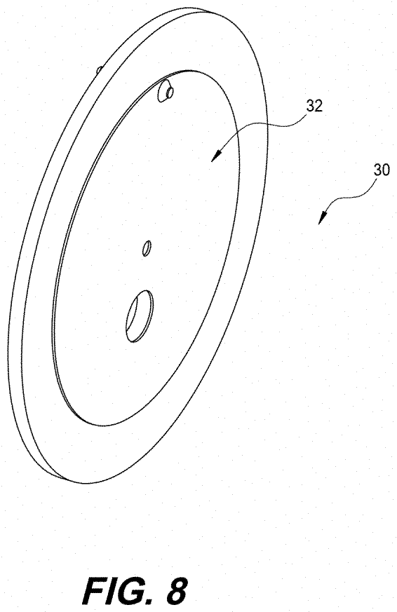

Printed circuit board 30 has a circular conductive layer 32, which is connected to outside electrically with a conductive pin 33 (also see FIG. 8). The print circuit board is fixed to upstream welding ring 14 by adhesive (101), such as epoxy, or screws. There is a gap d2 is formed between conductive layer 32 of printed circuit board 30 and the left surface of electrode 12. The third capacitor will be formed by the circular conductive layer 32 of printed circuit board 30 and electrode 12. The third variable capacitor can be powered and measured through connections 25 and 33.

Upstream fluid is connected to the circular slot chamber 28 through an upstream tube 18; downstream fluid is connected to a circular slot chamber 29 through a downstream tube 19. Assume upstream fluid pressure is higher than downstream pressure, under this differential pressure, the diaphragm 11 will be deflected rightwards, the gap d1 will increase. As the capacitance of the upstream variable capacitor is inversely proportional to the gap d1, the capacitance of upstream capacitor will reduce. By sensing this change through leads 25 and 27 with a circuit (not showing), the differential pressure change can be detected. Downstream variable capacitor can also be used to measure the differential pressure alone or combined with upstream variable capacitor to do so.

As the electrode 12 and upstream outside welding ring are connected by PCTFE or PTFE seam, the seam is not rigid, when there is internal pressure inside slot chamber 28, the electrode 12 will be deformed leftwards and the position of printed circuit board 30 is held on by upstream outside welding ring 14, the gap d2 will get smaller and the capacitance of the third capacitor will get bigger. The internal pressure change can be measured by the capacitance change through leads 25 and 34 with a circuit.

Side isolations 20, 21 and ring isolation 22 (they can be made from foam sheet) are used to provide a thermal isolation between the pressure sensor and environment. They can be attached to adjacent parts by adhesive. Covers 23 and 24, they are preferably made of stainless steel to facilitate spot welding, are providing a protection for the pressure sensor. They are spot-welded to the outside welding wings 14 and 15 described later in detail.

Temperature sensor 31 (demonstrated here is an RTD sensor) is plugged in to a blind hole of upstream electrode 12 and is fixed by thermal conductive adhesive (103). It is used to do temperature calibration during sensor build and temperature compensation during operation.

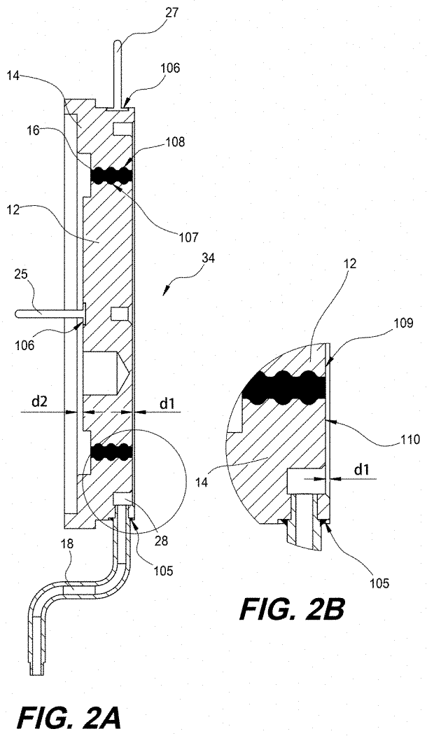

In FIG. 2A, upstream disk 34 consists of outside welding ring 14, PCTFE or PTFE seam 16, electrode 12, leads 25, 27 and upstream tube 18. Both outside welding ring 14 and electrode 12 are preferred to be made of 316L, 316L VIM/VAR or Inconel. The gap d1 between diaphragm 11 and electrode 12 is provided by a step machined on upstream welding ring 14 (FIG. 2B). The gap d1 can be controlled by machining and flashing surface 109 of electrode 12 and surface 110 of outside welding ring 14 during injection molding or compression molding of seam 16. An upstream tube 18 made of 316L or 316L VIM/VAR is fillet-welded to the outside welding ring 14 (105) by either TIG welding or laser welding. The slot chamber 28 not only provides a fluid path, it also plays an alignment role during PCTFE or PTFE molding (described later). Connect pins 25, 27 are made of copper or stainless steel and spot-welded (106) to electrode 12 and outside welding ring 14. Instead of using rigid connect pins, soft lead wires can also be used.

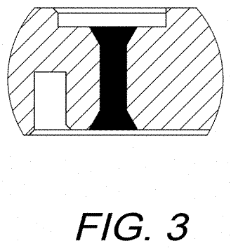

Outside peripheral of electrode 12 and inside peripheral of outside welding ring 14 are machined to curved profiles (107, 108), this will make the finished PCTFE and PTFE seam 16 with a curved profile. Curved profile will increase the ability of the seam to stand thermal impact and mechanical force caused by fluid pressure and handling. The profile of the PCTFE or PTFE can be any other shape, such as straight, or with counter sink ends, as shown in FIG. 3.

Downstream disk (see FIG. 1, consist of electrode 13, downstream outside welding ring 15, PCTFE or PTFE seam 17, leads 26 and downstream tube 19, can be manufactured and assembled in a similar way. One difference is that there is a curved surface 35 (FIG. 1), which will provide a stop for deformed diaphragm 11 to avoid overstressing of the diaphragm. By calculation, the stress of diaphragm 11 can be controlled below its yielding stress and provide an overpressure protection.

Although injection molding was not a recommended molding method (compression molding is) for PCTFE because regular injection molding will degrade the properties of PCTFE. But degrading may be avoided by controlling the heating and cooling procedures, and by controlling the contents of PCTFE. Considering the easiness of injection molding compared with compression molding, injection molding is the preferred way in this invention to join the electrode 12 and outside welding ring 14, as well as downstream electrode 13 and downstream outside welding ring 15.

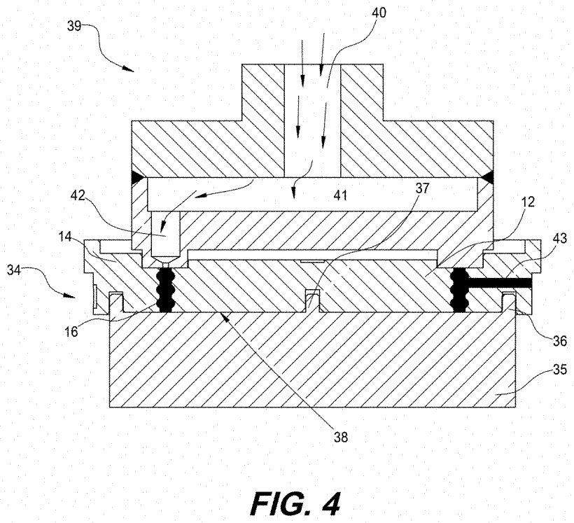

FIG. 4 shows how PCTFE can be injection molded. Electrode 12 and upstream outside welding ring 14 are put on an injection molding fixture base 35. They are concentrically aligned by the cylindrical protrusion flange 36 and pin 37 made on injection fixture base 35. They are also flushed by the surface 38 of injection fixture base 35. Injection head 39 is pressed down from the top of upstream disk 34. Then the melted PCTFE will flow in from the inlet port 40, fill the cavity 41 and go through four (can be other number) nozzles 42, fill the seam 16 confined by electrode 12, upstream outside welding ring 14, injection molding fixture base 35 and injection head 39.

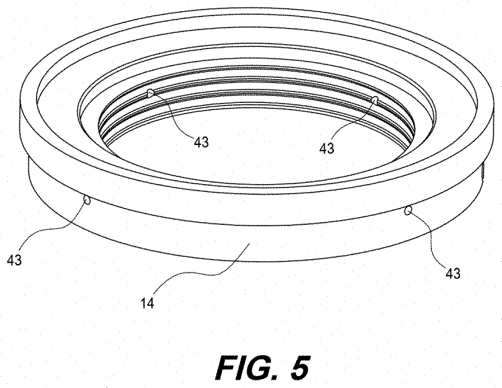

Referring to FIG. 5, there are four (can be other numbers) radial holes 43 machined on the outside welding ring 14. These holes are used to bleed air out during injection molding (see 43 in FIG. 4). They are placed 45° apart from nozzles 42 of injection head 39 during injection molding process. Once the seam 16 solidified, the injection head 39 can be lifted, and upstream disk 34 can be taken off.

The process of PCTFE injection molding for downstream disk is the same.

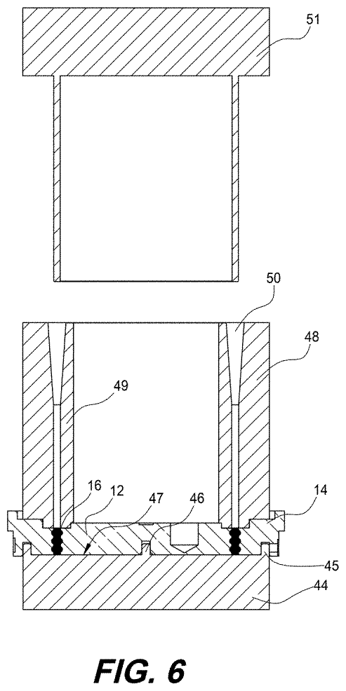

Unlike PCTFE, PTFE cannot be molded by injection molding, instead, compression molding can be used. FIG. 6 is a sketch showing the process of pressing PTFE powder into the seam. Electrode 12 and upstream outside welding ring 14 are put on an PTFE pressing fixture base 44. They are concentrically aligned by the flange 45 and pin 46 made on pressing fixture base 44. Electrode 12 and upstream outside welding ring 14 are also flushed by the surface 47. This is important to keep gap d1 (FIG. 1 and FIG. 2) consistence. Two cylinders 48 and 49 are put on the upstream outside welding ring 14 and electrode 12. Then PTFE powder is filled into the gap 50 formed by cylinders 48 and 49. As the density of molded PTFE is about 4.5 times of the density of PTFE powder, the volume of the gap 50 can be 4.5 times of that of final PTFE seam, so only one filling of PTFE powder is needed. After filling of PTFE powder, press head 51 will be pressed down. The range of the pressing pressure is between 1,500 psi to 5,500 psi. Higher press pressure will make the sintering shrinkage smaller. Press pressure also has influences on tensile strength and break elongation.

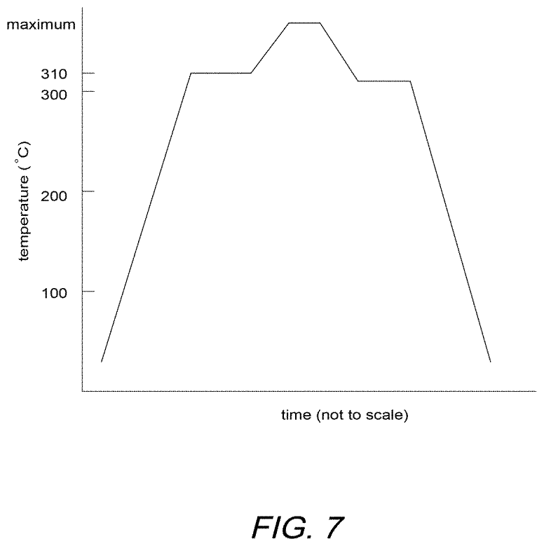

After pressing, next step will be sintering the PTFE. FIG. 7 shows a typical heating procedure.

Other than cost, PCTFE is better than PTFE in this application. Injection molding is easier than compression molding; PCTFE is much stronger than PTFE (tensile strength 34 MPa vs 10 MPa). Consequently, sensors made with PCTFE can be used in higher fluid pressure than the sensors made with PTFE. Other polymers can also be used, if their properties satisfy the requirements of the sensors.

After having upstream disk 34 (FIGS. 2A and 2B) and downstream disk made, the disks and diaphragm 11 can be welded together (100 in FIG. 1) by either TIG welding or laser welding.

Temperature sensor 31 can be put on this time with thermal conductive adhesive.

Printed Circuit Board 30 is showing in FIG. 8. Instead of using this regular PCB, ceramic based substrate with gold plated board can also be used, but the cost will be higher.

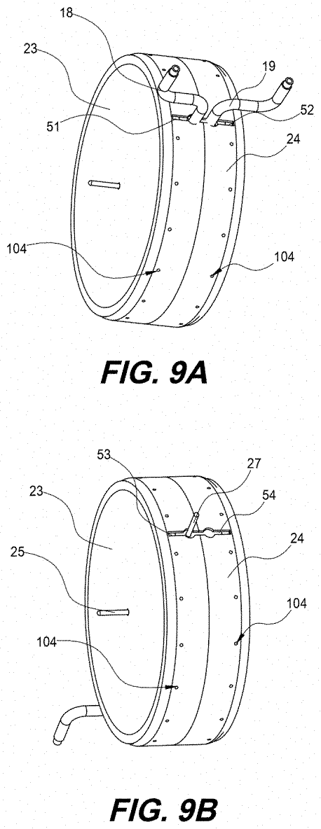

After PCB is fixed and isolation layers are put on (adhesive can be used), two covers 23 and 24 can be assembled (FIG. 9A and FIG. 9B). Cover 23 and 24 have precut slots 51, 52, 53 and 54. When assembling them, the slots will be forced open, the covers will be slid on. Finally, the covers 23 and 24 will be spot-welded to outside welding rings 14, and 15 (104). As the covers 23 and 24 are supported by the outside welding rings 14, and 15, any force caused by mishandling will not be passed onto electrodes 12 and 13 (see FIG. 1). The electrodes 12 and 13 are actually “floating”, only supported by PCTFE or PTFE seams. Consequently, other than fluid pressure force and thermal load caused by temperature change, they are not taking any other load.

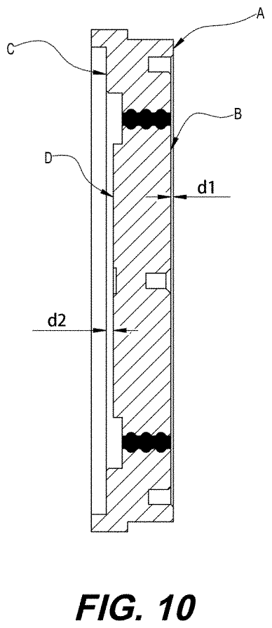

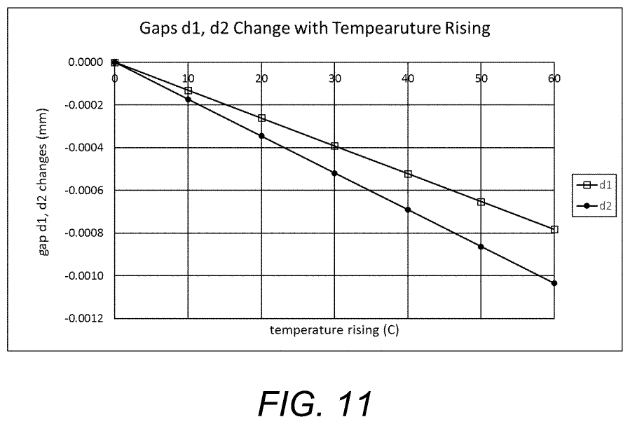

Although the gaps d1 and d2 are guaranteed by machining and assembling and easy to control, during the environmental temperature change, they are still going to change. FIG. 10 is a drawing for the thermal analysis of the disk with FEM (finite element method). Finite element method can be used to analysis how much the d1 and d2 will change if the whole disk is having a temperature change. This disk at surface A is fixed axially (no movement normal to surface A) and circumferentially (no rotation) but still allowed to move freely radially. d1 is the distance between surface A and surface B; d2 is the distance between surface C and D. With a room temperature of 22° C., the disk temperature can be increased until 82° C. Both gaps d1 and d2 are reducing with the increase of disk temperature. FIG. 11 shows this relationship. First, both gaps are linear, which makes temperature compensation easy and accurate. Second, at 60° C. temperature change, the reduction of d1 is about 0.001 mm. At the action of differential pressure alone, the full-scale change of d1 is about 0.18 mm. So, the error costs by temperature rise of 60° C. without compensation is about 0.56% of full-scale d1 change, but the temperature calibration is always needed. The temperature sensor 31 shown on FIG. 1 will be used to do the calibration. The data obtained will be saved in the sensor's circuit board (not showing). During operation, based on the live temperature measured by temperature sensor 31, the saved data will be used to compensate the pressure values. With temperature compensation, the influence caused by temperature change should be brought to a satisfactory level.

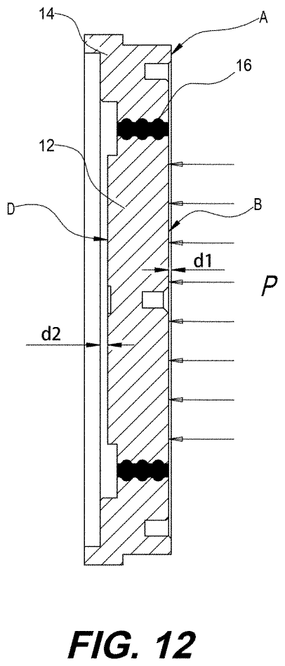

PCTFE or PTFE seam will deform under internal pressure, this will also change the values of gaps d1 and d2. FIG. 12 is a sketch used to do the FEA (finite element analysis) of this situation.

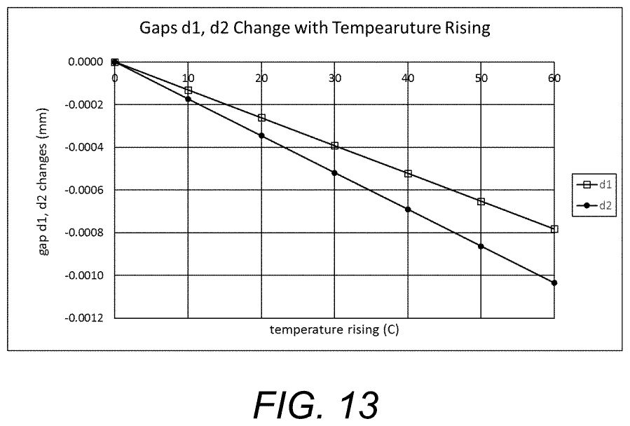

Surface A is fixed in the same way as in thermal analysis, and internal pressure is increased in steps. The electrode 12 will move to the left in addition to the deformation itself, this will make gap d1 larger and gap d2 smaller. Compare with the movement of the electrode 12, the bending and compression deformation of it can be ignored in the calculation. The increase of d1 can be treated as the decrease of d2. FIG. 13 shows the gap d1 increase (d2 decrease) with the pressure. It can be seen that this change is also linear (as it should be). The deformation under internal pressure can be calibrated with the third capacitor formed by PCB 30 and the electrode 12 and add to the d1 change. At the same time, the third capacitor can measure the line pressure instantaneously. This data will also be saved in the memory of circuit board and be used during operation.

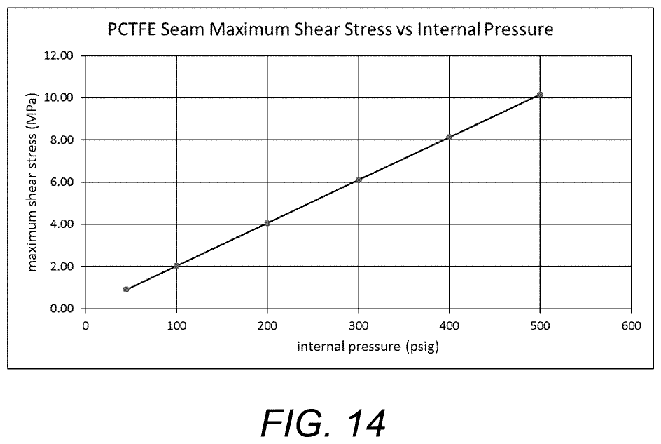

Under internal pressure, the PCTFE or PTFE seam should stay at elastic range without permanent deformation, and the seam should be strong enough to stand working pressure and specified maximum pressure. FIG. 12 is used to analyze the seam stress with FEM. FIG. 14 shows the maximum shear stress inside the PCTFE seam 16. The ordinary working pressure in semiconductor process is around 45 psig and not to surpass 100 psig. In this pressure range, the maximum shear stress is only around 2 MPa, which is considered as a safe value considering that the tensile stress of PCTFE is >35 MPa. 500 psig is usually the maximum pressure for a pressure sensor, and at this pressure, the maximum shear stress of the PCTFE seam is around 10 MPa, which is still not very big compared to its tensile strength.

Persons skilled in the art will appreciate that although semiconductor applications have been described in this application, the described pressure sensor can also be used for food, medical and other industries.

The invention may be embodied in other specific forms without departing from the spirit or essential characteristics thereof. For example, in FIG. 1, if the downstream tube 19 is open to atmosphere and upstream tube 18 is connected to a pressure source to be measured, the device 10 becomes a gauge pressure sensor. If chamber 29 is vacuumed and tube 19 is sealed afterwards, tube 18 is connected to a pressure source, device 10 becomes an absolute pressure sensor. If the slot chamber 28 was vacuumed and upstream tube 18 was sealed afterwards, tube 19 is connected to a vacuum source, the device 10 becomes a barometer.

What is claimed is:

1. A pressure sensor comprising:
a conductive diaphragm;
a pair of outside welding rings welded together with the diaphragm;
a pair of electrodes coupled to the pair of outside welding rings via polymer seams;
a printed circuit board mounted on the outside welding ring; and
a temperature sensor.

2. The pressure sensor of claim 1 wherein Polychlorotrifluoroethylene (PCTFE) or Polytetrafluoroethylene (PTFE) or other polymer is used to join electrode and outside welding ring together by injection molding or compression molding.

3. The pressure sensor of claim 1, the profile of the polymer seam is curved or straight.

4. The pressure sensor of claim 1 wherein the electrodes and diaphragm form capacitors to measure differential pressure, the electrodes and PCB form capacitor to measure the line pressure.

5. The pressure sensor of claim 1 further comprising
one or more ports formed on the pair of outside welding rings, wherein the ports expose the pressure sensor to pressure or vacuum sources or atmosphere, make the pressure sensor an absolute pressure sensor, gauge pressure sensor, differential pressure sensor or barometer.

6. The pressure sensor of claim 1, the temperature sensor is used to do thermal calibration and temperature compensation.

7. The pressure sensor of claim 1, wherein the pressure sensor is an absolute pressure sensor, a gauge pressure sensor, a differential pressure sensor, or a barometer.
